(19) United States
(12) Patent Application Publication
(10) Pub. No.: US 2026/0006080 A1
(43) Pub. Date: Jan. 1, 2026

(54) ADAPTABLE, SCALABLE, AND AUTONOMOUS PROTECTION VERIFICATION AND DECISION SUPPORT

(71) Applicant: Raytheon Company, Tewksbury, MA (US)

(72) Inventors: Paul C. Hershey, Ashburn, VA (US); Laura D. Strater, Dallas, TX (US)

(21) Appl. No.: 18/805,031

(22) Filed: Aug. 14, 2024

Related U.S. Application Data
(60) Provisional application No. 63/666,577, filed on Jul. 1, 2024.

(51) Int. Cl. H04L 9/40

(52) U.S. Cl. CPC H04L 63/20

(57) ABSTRACT

A method includes obtaining information associated with assets and/or personnel to be protected and executing a set of weighting functions and a set of algorithms for protecting the assets and/or personnel. The weighting functions and algorithms are arranged in multiple levels of a hierarchy. Each level of the hierarchy includes one or more of the weighting functions and one or more of the algorithms. The one or more weighting functions and the one or more algorithms in at least one level of the hierarchy are applied across a timeline. The method also includes applying an artificial intelligence/machine learning (AI/ML) algorithm across the timeline to update results due to one or more changes during one or more operations involving the assets and/or personnel.

### CROSS-REFERENCE TO RELATED APPLICATION AND PRIORITY CLAIM

This application claims priority under 35 U.S.C. § 119 (e) to U.S. Provisional Patent Application No. 63/666,577 filed on Jul. 1, 2024, which is hereby incorporated by reference in its entirety.

### TECHNICAL FIELD

This disclosure is generally directed to decision systems. More specifically, this disclosure is directed to adaptable, scalable, and autonomous protection verification and decision support.

### BACKGROUND

There are various situations in which it may be necessary or desirable to verify whether personnel or assets are adequately protected. These situations include both civilian and military personnel and assets.

### SUMMARY

This disclosure relates to adaptable, scalable, and autonomous protection verification and decision support.

In a first embodiment, a method includes obtaining information associated with assets and/or personnel to be protected and executing a set of weighting functions and a set of algorithms for protecting the assets and/or personnel. The weighting functions and algorithms are arranged in multiple levels of a hierarchy. Each level of the hierarchy includes one or more of the weighting functions and one or more of the algorithms. The one or more weighting functions and the one or more algorithms in at least one level of the hierarchy are applied across a timeline. The method also includes applying an artificial intelligence/machine learning (AI/ML) algorithm across the timeline to update results due to one or more changes during one or more operations involving the assets and/or personnel.

In a second embodiment, an apparatus includes at least one processing device configured to obtain information associated with assets and/or personnel to be protected and execute a set of weighting functions and a set of algorithms for protecting the assets and/or personnel. The weighting functions and algorithms are arranged in multiple levels of a hierarchy. Each level of the hierarchy includes one or more of the weighting functions and one or more of the algorithms. The one or more weighting functions and the one or more algorithms in at least one level of the hierarchy are applied across a timeline. The at least one processing device is also configured to apply an AI/ML algorithm across the timeline to update results due to one or more changes during one or more operations involving the assets and/or personnel.

In a third embodiment, a non-transitory computer readable medium contains instructions that when executed cause at least one processor to obtain information associated with assets and/or personnel to be protected and execute a set of weighting functions and a set of algorithms for protecting the assets and/or personnel. The weighting functions and algorithms are arranged in multiple levels of a hierarchy. Each level of the hierarchy includes one or more of the weighting functions and one or more of the algorithms. The one or more weighting functions and the one or more algorithms in at least one level of the hierarchy are applied across a timeline. The non-transitory computer readable medium also contains instructions that when executed cause the at least one processor to apply an AI/ML algorithm across the timeline to update results due to one or more changes during one or more operations involving the assets and/or personnel.

Any single one or any combination of the following features may be used with the first, second, or third embodiment. For at least one level of the hierarchy, the one or more weighting functions and the one or more algorithms may be applied across the timeline based on one or more probability distribution functions. The one or more probability distribution functions may be derived through curve fitting. The AI/ML algorithm may be configured to dynamically establish and apply policies for a protection update function and optimization of critical personnel or asset protection across the timeline. The AI/ML algorithm may include a reinforcement learning algorithm. Processing resources may be dynamically scaled to accommodate protection decision-making associated with an increasing or decreasing number of assets and/or personnel to be protected prior to and during the timeline. Each level of the hierarchy may be associated with at least one of: one or more priorities, one or more mission objectives, and one or more desired outcomes. The AI/ML algorithm may increase assessment fidelity and associated confidence.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example system supporting adaptable, scalable, and autonomous protection verification and decision support according to this disclosure;

FIG. 2 illustrates an example device supporting adaptable, scalable, and autonomous protection verification and decision support according to this disclosure;

FIG. 3 illustrates an example process supporting adaptable, scalable, and autonomous protection verification and decision support according to this disclosure;

FIGS. 4A through 4C illustrate example operations performed as part of the process of FIG. 3 according to this disclosure;

FIG. 5 illustrates example results obtained using the process of FIG. 3 according to this disclosure;

FIG. 6 illustrates an example artificial intelligence/machine learning (AI/ML) approach for establishing and applying policies for protection verification and decision support over time according to this disclosure;

FIG. 7 illustrates example results from using the AI/ML approach of FIG. 6 according to this disclosure;

FIG. 8 illustrates an example method for adaptable, scalable, and autonomous protection verification and decision support according to this disclosure; and

FIG. 9 illustrates an example method for using AI/ML to establish and apply policies for protection verification and decision support over time according to this disclosure.

### DETAILED DESCRIPTION

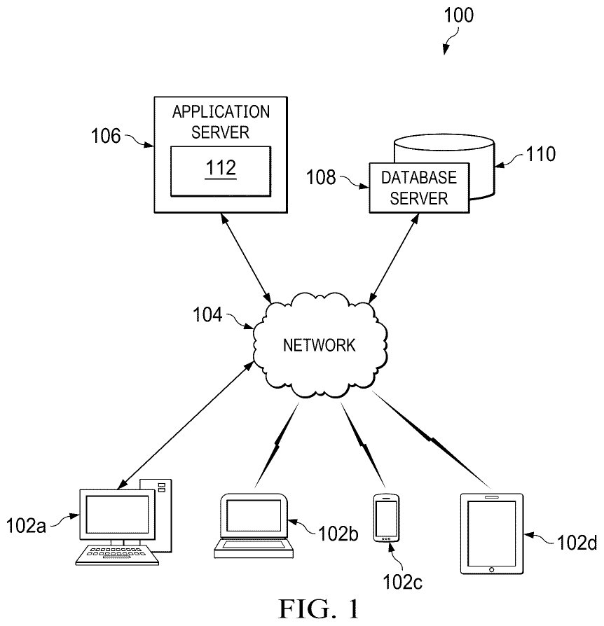

FIGS. 1 through 9, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

As noted above, there are various situations in which it may be necessary or desirable to verify whether personnel or assets are adequately protected. These situations include both civilian and military personnel and assets. For example, police, firefighter, and other emergency response departments, industrial control systems, critical infrastructure, and financial systems are associated with personnel and assets that need to be protected during their respective emergency response operations or other operations. As another example, military operations are associated with personnel and assets that need to be protected before, during, and after mission engagements.

Unfortunately, various approaches for verifying whether personnel or assets are adequately protected suffer from a number of shortcomings. For instance, various approaches rely on subjective evaluations by subject matter experts, are limited to a relatively small number of personnel or assets, and cannot be timely adapted over time. As a result, there is generally not an effective way to objectively verify that personnel or assets are protected in an adaptable, scalable, and autonomous manner.

This disclosure provides various techniques for adaptable, scalable, and autonomous protection verification and decision support that overcome these or other issues. As described in more detail below, information associated with assets and/or personnel to be protected can be obtained, and a set of weighting functions and a set of algorithms for protecting the assets and/or personnel can be executed. The weighting functions and the algorithms can be arranged in multiple levels of a hierarchy. Each level of the hierarchy can be associated with one or more priorities, mission objectives, and/or desired outcomes. Also, each level of the hierarchy can include one or more of the weighting functions and one or more of the algorithms. The one or more weighting functions and the one or more algorithms in at least one level of the hierarchy can be applied across a timeline. An artificial intelligence/machine learning (AI/ML) algorithm can be applied across the timeline to update results due to one or more changes during one or more operations involving the assets and/or personnel. In some cases, the one or more weighting functions and the one or more algorithms for at least one level can be applied across the timeline based on one or more probability distribution functions, which could be derived through curve fitting or other data characterization. In some embodiments, the AI/ML algorithm may include a reinforcement learning algorithm. Optionally, processing resources can be dynamically scaled to accommodate protection decision-making associated with an increasing or decreasing number of assets and/or personnel to be protected prior to and during the timeline. In this way, the described techniques support adaptable, scalable, and autonomous protection verification and decision support, where objective determinations can be made for any suitable number of personnel and/or assets and where those objective determinations can be adapted over time.

FIG. 1 illustrates an example system 100 supporting adaptable, scalable, and autonomous protection verification and decision support according to this disclosure. As shown in FIG. 1, the system 100 includes multiple user devices 102a-102d, at least one network 104, at least one application server 106, and at least one database server 108 associated with at least one database 110. Note, however, that other combinations and arrangements of components may also be used here.

In this example, each user device 102a-102d is coupled to or communicates over the network 104. Communications between each user device 102a-102d and a network 104 may occur in any suitable manner, such as via a wired or wireless connection. Each user device 102a-102d represents any suitable device or system used by at least one user to provide information to the application server 106 or database server 108 or to receive information from the application server 106 or database server 108. Any suitable number(s) and type(s) of user devices 102a-102d may be used in the system 100. In this particular example, the user device 102a represents a desktop computer, the user device 102b represents a laptop computer, the user device 102c represents a smartphone, and the user device 102d represents a tablet computer. However, any other or additional types of user devices may be used in the system 100. Each user device 102a-102d includes any suitable structure configured to transmit and/or receive information.

The network 104 facilitates communication between various components of the system 100, such as via wired or wireless connections. For example, the network 104 may communicate Internet Protocol (IP) packets, frame relay frames, Asynchronous Transfer Mode (ATM) cells, or other suitable information between network addresses. The network 104 may include one or more local area networks (LANs), metropolitan area networks (MANs), wide area networks (WANs), all or a portion of a global network such as the Internet, or any other communication system or systems at one or more locations. The network 104 may also operate according to any appropriate communication protocol or protocols.

The application server 106 is coupled to the network 104 and is coupled to or otherwise communicates with the database server 108. The application server 106 supports the execution of one or more applications 112, at least one of which is designed to provide adaptable, scalable, and autonomous protection verification and decision support. For example, the application 112 may perform various functions described below to identify critical personnel and/or assets and determine whether adequate protection is or can be made available for those personnel and/or assets. One or more of these functions may be implemented using a set of weighting functions and a set of algorithms arranged in multiple levels of a hierarchy, where different levels of the hierarchy are associated with different priorities, mission objectives, and/or desired outcomes. Each level of the hierarchy could include one or more weighting functions and one or more algorithms that are applied across a timeline.

The database server 108 operates to store and facilitate retrieval of various information used, generated, or collected by the application server 106 and the user devices 102a-102d in the database 110. For example, the database server 108 may store various information in relational database tables or other data structures in the database 110. In some embodiments, the database 110 can be used to store and facilitate retrieval of information used by the application server 106 to provide adaptable, scalable, and autonomous protection verification and decision support. Note that the database server 108 may also be used within the application server 106 to store information, in which case the application server 106 may store the information itself.

Although FIG. 1 illustrates one example of a system 100 supporting adaptable, scalable, and autonomous protection verification and decision support, various changes may be made to FIG. 1. For example, the system 100 may include any suitable number of user devices 102a-102d, networks 104, application servers 106, database servers 108, and databases 110. Also, these components may be located in any suitable locations and might be distributed over a large area. In addition, while FIG. 1 illustrates one example operational environment in which adaptable, scalable, and autonomous protection verification and decision support may be used, this functionality may be used in any other suitable system.

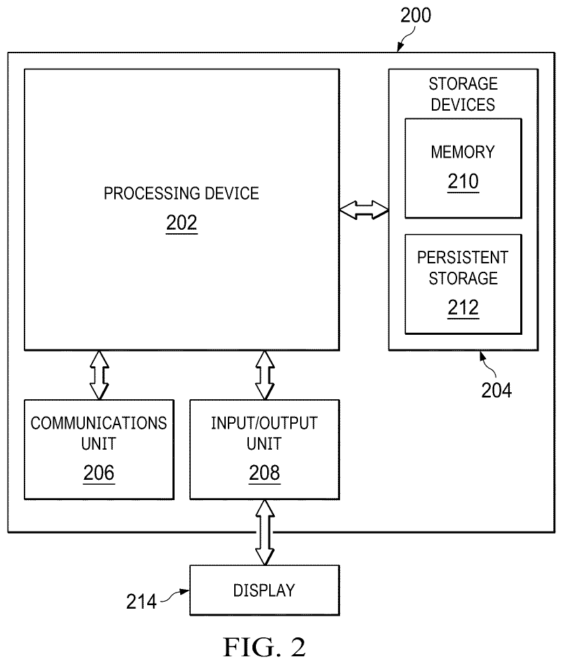

FIG. 2 illustrates an example device 200 supporting adaptable, scalable, and autonomous protection verification and decision support according to this disclosure. One or more instances of the device 200 may, for example, be used to at least partially implement the functionality of a user device 102a-102d, application server 106, or database server 108 in FIG. 1. However, each of these components may be implemented in any other suitable manner.

As shown in FIG. 2, the device 200 denotes a computing device or system that includes at least one processing device 202, at least one storage device 204, at least one communications unit 206, and at least one input/output (I/O) unit 208. The processing device 202 may execute instructions that can be loaded into a memory 210. The processing device 202 includes any suitable number(s) and type(s) of processors or other processing devices in any suitable arrangement. Example types of processing devices 202 include one or more microprocessors, microcontrollers, digital signal processors (DSPs), application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 can include a network interface card or a wireless transceiver facilitating communications over a wired or wireless network. The communications unit 206 may support communications through any suitable physical or wireless communication link(s). As a particular example, the communications unit 206 may support communication over the network(s) 104 of FIG. 1.

The I/O unit 208 allows for input and output of data. For example, the I/O unit 208 may provide a connection for user input through a keyboard, mouse, keypad, touchscreen, or other suitable input device. The I/O unit 208 may also send output to a display 214 or other suitable output device. Note, however, that the I/O unit 208 may be omitted if the device 200 does not require local I/O, such as when the device 200 represents a server or other device that can be accessed remotely.

In some embodiments, instructions can be executed by the processing device 202 in order to implement the functionality of the one or more applications 112. For example, the processing device 202 may execute instructions that cause the processing device 202 to provide adaptable, scalable, and autonomous protection verification and decision support. Example processes and functions that may be performed by the processing device 202 to provide adaptable, scalable, and autonomous protection verification and decision support are described below.

Although FIG. 2 illustrates one example of a device 200 supporting adaptable, scalable, and autonomous protection verification and decision support, various changes may be made to FIG. 2. For example, computing and communication devices and systems come in a wide variety of configurations, and FIG. 2 does not limit this disclosure to any particular computing or communication device or system.

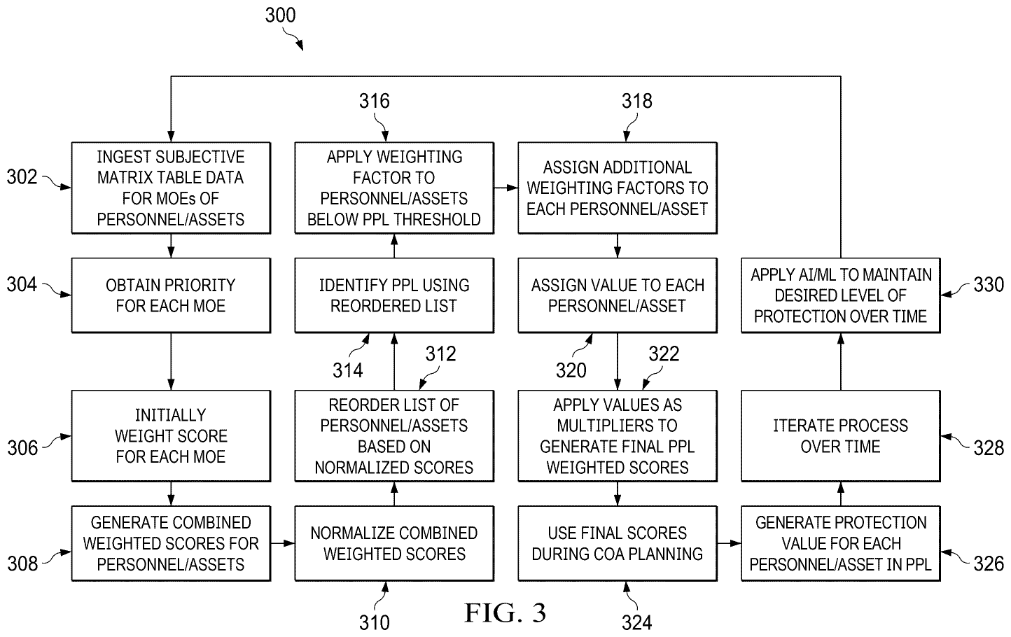

FIG. 3 illustrates an example process 300 supporting adaptable, scalable, and

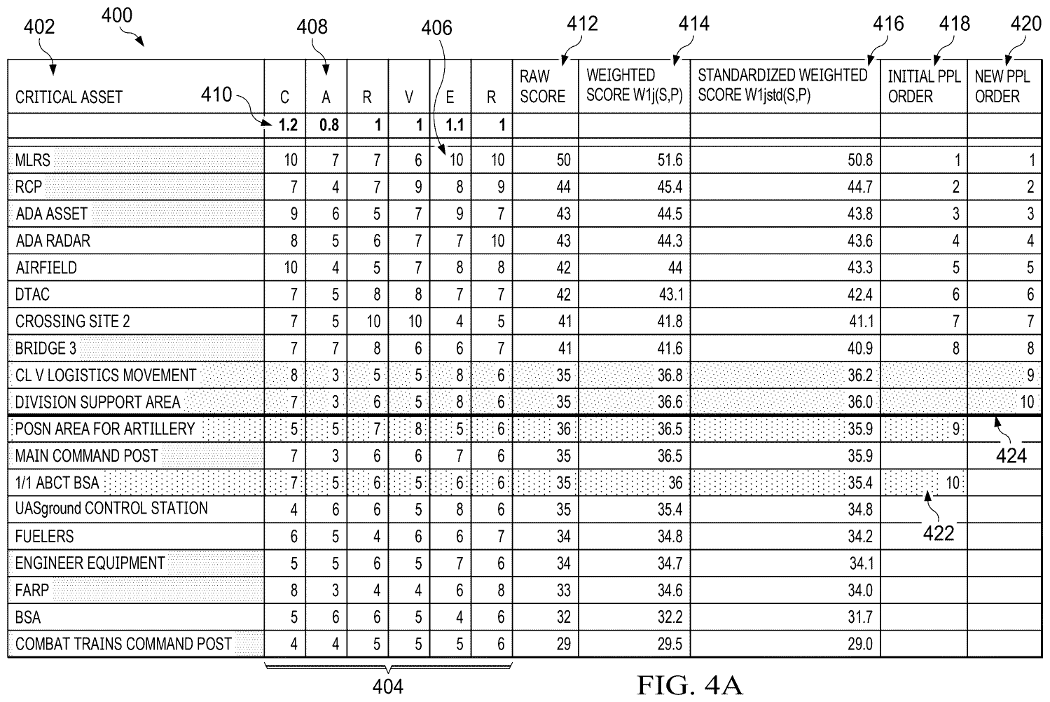

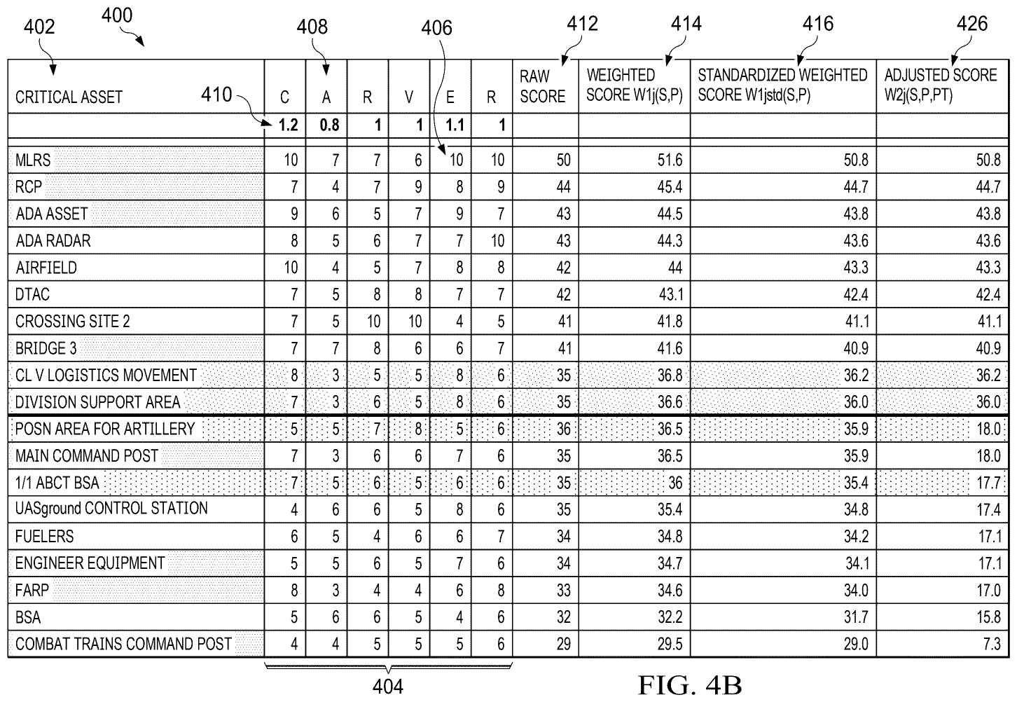

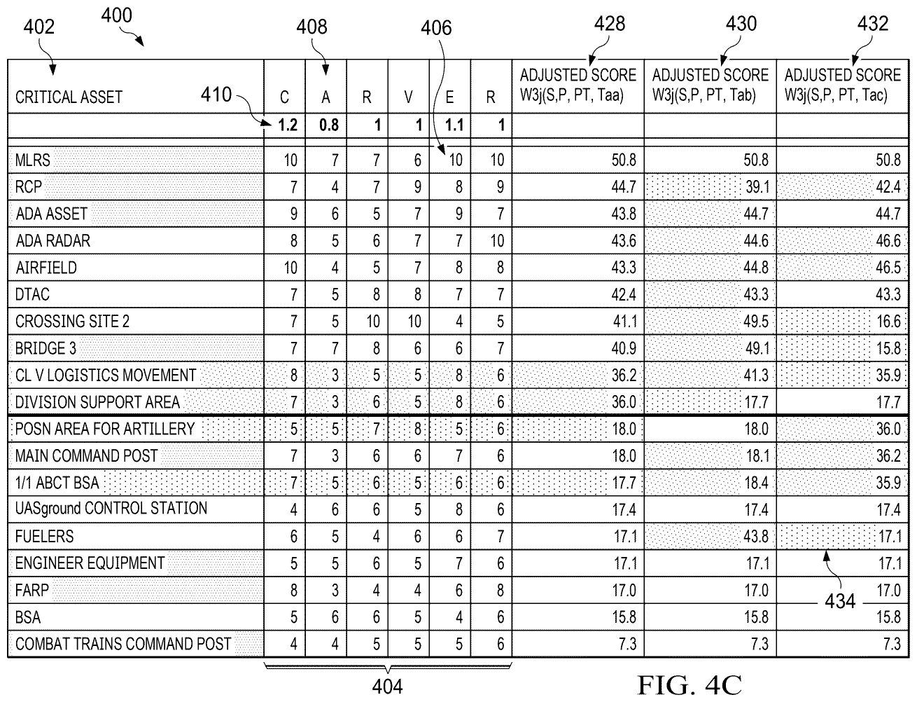

autonomous protection verification and decision support according to this disclosure. FIGS. 4A through 4C illustrate example operations performed as part of the process 300 of FIG. 3 according to this disclosure. For ease of explanation, the process 300 and its operations shown in FIGS. 3 through 4C may be described as being implemented or supported using various components in the system 100 of FIG. 1, at least one of which may be implemented using one or more instances of the device 200 shown in FIG. 2. However, the process 300 and its operations shown in FIGS. 3 through 4C may be implemented or supported by any suitable device(s) and in any suitable system(s).

As shown in FIG. 3, the process 300 begins with an ingestion function 302 in which subjective matrix table data related to personnel and/or assets is obtained. For example, the matrix table data may identify each person and/or asset that might need to be protected. For each person and/or asset, the matrix table data may represent or include scores for various measures of effectiveness (MOEs) related to that person or asset. As a particular example, the matrix table data may include scores for each person or asset related to the “CARVER” measures of effectiveness. CARVER is a well-known risk assessment scheme that uses subjective scores for the following MOEs for personnel and/or assets: criticality (how essential a person or asset is), accessibility (how hard it would be for an adversary to access or attack the person or asset), recoverability (how quickly recovery could occur if something happens to the person or asset), vulnerability (whether or how well the person or asset could withstand an adversary's attack), effect (how much of an impact there would be if something happens to the person or asset), and recognizability (how likely it is that an adversary recognizes the person or asset as a valuable target). However, other risk assessment schemes may be used, such as the “CARVE” risk assessment scheme (which omits recognizability). For each MOE in the matrix table data, a score can be identified for that MOE. In some cases, the matrix table data can include subjective scores from one or more mission commanders or other people responsible for overseeing use of the personnel and/or assets. In some embodiments, the processing device 202 of the application server 106 may retrieve the matrix table data from the database 110 or obtain the matrix table data from one or more users via one or more user devices 102a-102d.

One example of this is shown in FIG. 4A, where a table 400 includes a list 402 of personnel and/or assets. In this example, the list 402 identifies a collection of critical assets associated with military equipment, although the list 402 may identify any suitable collection of personnel and/or assets that might need protection. The table 400 also includes matrix table data 404, where the matrix table data 404 includes (for each person and/or asset in the list 402) a score 406 for each of multiple MOEs 408. In this example, the MOEs 408 relate to the CARVER risk assessment scheme, although other MOEs may be used as needed or desired. Each score 406 here may represent a numerical value within a range of values, such as integer values between a minimum of zero and a maximum of ten. Note, however, that other ranges and/or increments may be used.

During a prioritization function 304, a priority for each MOE 408 in the matrix table data 404 can be identified. For example, there may be a priority assigned to each of the criticality, accessibility, recoverability, vulnerability, effect, and recognizability MOEs 408 (if the CARVER risk assessment scheme is used). Each priority value can be applied to the corresponding MOE 408 across all personnel and/or assets in the list 402. As a particular example, each priority value may be assigned a value between a minimum of zero and a maximum of two, and each priority value may be incremented or decremented in 0.1 steps. Note, however, that other ranges and/or increments may be used. In some embodiments, the processing device 202 of the application server 106 may retrieve the priorities from the database 110 or obtain the priorities from one or more users via the one or more user devices 102a-102d. One example of this is shown in FIG. 4A, where priorities 410 have been associated with the various MOEs 408.

During an initial weighting function 306, a weighted score for each MOE 408 is determined. For example, for each person and/or asset in the list 402, the score of each MOE 408 for that person or asset can be multiplied by the priority 410 of that MOE 408. In some embodiments, the processing device 202 of the application server 106 may perform the multiplication operations based on the obtained data in order to generate the weighted scores. During a generation function 308, for each person and/or asset in the list 402, the resulting values across all MOEs 408 for that person or asset can be summed or otherwise combined to generate a combined weighted score for that person or asset. In some embodiments, the processing device 202 of the application server 106 may perform summations of the weighted values to generate the combined weighted scores. One example of this is shown in FIG. 4A, where raw scores 412 and weighted scores 414 are provided for each person and/or asset identified in the list 402. Here, the raw scores 412 are generated by summing the individual scores 406 for each person and/or asset identified in the list 402. The weighted scores 414 are generated by multiplying the individual scores 406 for each person and/or asset in the list 402 by the priorities 410 corresponding to the MOEs 408 and summing the resulting products.

During a normalization function 310, the combined weighted scores 414 are normalized by converting the combined weighted scores 414 back to an expected scale. For example, each combined weighted score 414 can be multiplied by a multiplier that converts the combined weighted score 414 back to a standard scale, such as a standard sixty-point CARVER scale. The standard sixty-point CARVER scale is based on the assumption that six MOEs 408 may each have a score 406 between zero and ten, so the raw scores 412 can be generated by summing the six scores 406 for each person or asset (meaning the raw scores 412 may range between zero and sixty). However, the weighting of the scores 406 by the MOE priorities 410 during the initial weighting function 306 can skew the weighted scores 414, so the normalization function 310 can normalize the combined weighted scores 414 to compensate for this. In some cases, an average of the combined weighted scores 414 may be determined, and an inverse of the average can be used as a multiplier for each combined weighted score 414. In some embodiments, the processing device 202 of the application server 106 may perform averaging and multiplication operations to generate the normalized combined weighted scores. One example of this is shown in FIG. 4A, where the weighted scores 414 are normalized to produce standardized weighted scores 416. The initial weighting and normalization here may be said to represent the first level of a hierarchical-based weighting process.

During a reordering function 312, the personnel and/or assets in the list 402 are reordered based on the normalized or standardized weighted scores 416. Any personnel and/or assets in the list 402 that move or change position within the list 402 may optionally be identified to one or more users. In some embodiments, the processing device 202 of the application server 106 may reorder the list 402 by ranking the personnel and/or assets in the list 402 in order of decreasing or increasing standardized weighted scores 416. One example of this is shown in FIG. 4A, where the personnel and/or assets in the list 402 have been ranked in order of decreasing standardized weighted scores 416. A ranking 418 identifies the original position of each person and/or asset in the list 402 based on the raw scores 412, and an updated ranking 420 identifies the updated position of each person and/or asset in the list 402 based on the standardized weighted scores 416. Shading or other indicators 422 may be used to identify any personnel and/or assets in the list 402 whose position(s) changed between the rankings 418 and 420, such as when green highlighting is used to identify a person or asset that moved higher in the list 402 and red highlighting is used to identify a person or asset that moved lower in the list 402. Among other things, this may allow the one or more users to visually see the impact of the priorities 410 assigned to the MOEs 408.

During an identification function 314, the reordered list 402 of personnel and/or assets is used to identify a prioritized protection list (PPL). The prioritized protection list is said to represent a listing of the personnel and/or assets in the reordered list 402 for which protection should be prioritized above other personnel and/or assets. In some cases, a threshold score may be determined, and any personnel and/or assets having standardized weighted scores 416 above the threshold may be included in the prioritized protection list. In other cases, a specified number of personnel and/or assets having the highest standardized weighted scores 416 may be included in the prioritized protection list. In some embodiments, the processing device 202 of the application server 106 may select the personnel and/or assets in the reordered list 402 based on their normalized weighted scores 416. One example of this is shown in FIG. 4A, where a cutoff 424 is identified and where all personnel and/or assets above the cutoff 424 can be included in the prioritized protection list.

During an application function 316, a weighting factor is assigned and applied to at least the people and/or assets in the reordered list 402 below the cutoff 424. For example, each person and/or asset in the reordered list 402 above the cutoff 424 may be assigned a weighting factor of 1.0 (or may remain unchanged), while each person and/or asset in the reordered list 402 below the cutoff 424 may be assigned a weighting factor of 0.25 or 0.5. In some cases, these values of the weighting factor may be assigned by one or more mission commanders or other people responsible for overseeing use of the personnel and/or assets. Applying these weighting factors to the standardized weighted scores 416 can result in the generation of adjusted scores for the personnel and/or assets. In some cases, the weighting factor(s) assigned to the personnel and/or assets in the reordered list 402 may be based on user input. In some embodiments, the processing device 202 of the application server 106 may perform multiplications to scale the normalized weighted scores 416. One example of this is shown in FIG. 4B, where the standardized weighted scores 416 have been weighted to produce adjusted scores 426. The threshold here may be said to represent the second level of a hierarchical-based weighting process.

During an assignment function 318, one or more additional weighting factors are assigned to each person or asset in the reordered list 402. For example, if the people and/or assets in the list 402 can be used during different phases across a timeline, the assignment function 318 can apply different weighting factors (such as different priorities 410 or scores 406) to each person or asset in the reordered list 402 during the different phases. During an assignment function 320, these one or more additional weighting factors can be assigned to the personnel and/or assets in the reordered list 402. During an application function 322, these values can be applied as multipliers to the adjusted scores 426 in order to generate additional adjusted scores for the personnel and/or assets. In some embodiments, the processing device 202 of the application server 106 may perform multiplications to scale the adjusted scores 426. The assignment function 318 can apply one or more algorithms to increase assessment fidelity and associated confidence when identifying the one or more additional weighting factors. For instance, the assignment function 318 can use one or more probability distribution functions and/or other data characterizations, which in some cases may allow associated confidence levels to be generated when the one or more additional weighting factors are applied.

One example of this is shown in FIG. 4C, where the adjusted scores 426 have been scaled using three additional weighting factors to produce additional adjusted scores 428, 430, and 432 for each person and/or asset. The additional adjusted scores 428, 430, and 432 here are associated with different phases (denoted Taa, Tab, and Tac) across the relevant timeline. For the additional adjusted scores 430 and 432, indicators 434 can be used to identify when an additional adjusted score 430 or 432 for a person or asset changes relative to the original adjusted score 426 or relative to the preceding additional adjusted score 428 or 430, such as when green highlighting is used to identify a higher additional adjusted score and red highlighting is used to identify a lower additional adjusted score.

A planning function 324 can use the additional adjusted scores 428-432 for the personnel and/or assets in the prioritized protection list as part of a course of action (COA) generation planning process, which can identify one or more courses of action that may be undertaken using the personnel and/or assets in the prioritized protection list. A generation function 326 can identify protection values for at least some of the personnel and/or assets in the prioritized protection list. The COA generation planning process may represent or be implemented using a tool that can be used to plan operations that could occur using at least some of the personnel and/or assets in the prioritized protection list. Various types of warfighting planning tools or other civilian or defense-related operations planning tools are known in the art, and additional tools are sure to be developed in the future. As a particular example, the “Warfighter Intelligent System for Distinct Domain Operational Missions” or WISDDOM™ tool from RAYTHEON CO. may be used during the COA generation planning process. The generation function 326 can generate any suitable information for the personnel and/or assets in the prioritized protection list, such as damage estimates. Highlighting may be used to identify which personnel and/or assets in the prioritized protection list are most at risk for each course of action based on the results of the generation function 326. For instance, there can be a known set of defense assets for a course of action that may be used to provide protection for the personnel and/or assets in the prioritized protection list. If there are inadequate defense assets for a person or asset in the prioritized protection list, that person or asset can be identified. In response to the identification of any personnel and/or assets that are not adequately protected, changes to one or more courses of action may be made automatically or based on user input, such as by changing the set of defense assets available for the course of action.

An iteration function 328 indicates that the process can occur iteratively, such as when the earlier functions 302-326 occur for each operational phase or other desired time-based periods. An application function 330 applies one or more artificial intelligence/machine learning (AI/ML) algorithms to maintain a required or desired level of protection for the personnel and/or assets in the prioritized protection list. For example, the one or more AI/ML algorithms may generate and update policies in order to maintain the required or desired level of protection throughout a mission or other operation as a selected course of action changes. In some embodiments, the processing device 202 of the application server 106 may use reinforcement learning as at least part of the one or more AI/ML algorithms.

As noted above, the process 300 supports the use of a hierarchical-based weighting process, where different levels of the weighting process can be associated with different weighting functions and/or different algorithms. With respect to the weighting functions, the input to the hierarchical-based weighting process can include the original subjectively-derived scores, meaning the scores 406 for the various MOEs 408. The following now provides example details of how certain ones of the functions of the process 300 shown in FIG. 3 may be implemented. Note that these example details relate to specific implementations of the process 300 and that other implementations may execute or perform the various functions shown in FIG. 3 in different ways.

The overall weighting process supported in FIG. 3 may assume that weighted scores can be generated as follows.

$$W = f ( S , P , PT , T )$$

Here, W represents a weighted score, S represents an original score 406, P represents a priority 410, PT represents a priority threshold, and T represents time. The priority threshold may represent a maximum number of people and/or assets to be protected and in some cases can be used to identify the cutoff 424. The time may represent a time (such as in days, hours, minutes, and seconds) associated with a particular mission phase or other operational phase. Each weighting function in the overall weighting process supported in FIG. 3 may be a function of some or all of these characteristics.

As noted above, the first level in the hierarchical-based weighting process can be used to generate the weighted scores 414 and the standardized weighted scores 416, where the first level in the hierarchical-based weighting process is implemented using the functions 306-310. The weighted scores 414 and the standardized weighted scores 416 can be generated as functions of the original scores 406 and the priorities 410. With respect to the functions 306 and 308, the score 406 of each MOE 408 for a person or asset in the list 402 can be multiplied by the corresponding priority 410 of that MOE 408, and the resulting products can be combined to generate weighted scores 414. In some embodiments, each scaled MOE score (denoted W1) can be a function of the original score 406 (denoted S) and the associated priority 410 (denoted P). Thus, each scaled MOE score may be expressed as follows.

$$W 1 = f ( S , P )$$

The scaled MOE scores for each person or asset in the list 402 can be combined to generate the weighted score 414 for that person or asset. Thus, each weighted score 414 (denoted W1j) may be expressed as follows.

$$W 1 j = ( {\sum }_{k = 1}^{n} SjkPk )$$

Here, n represents the total number of people and/or assets in the list 402, and j represents an index to the j^{th} person or asset in the list 402 (where 1≤j≤n). Also, k represents an index to the k^{th} MOE 408, where 1<k≤m and where m represents the total number of MOEs 408. In addition, Sjk represents the score 406 for the k^{th} MOE 408 related to the j^{th} person or asset, and Pk represents the priority 410 for the k^{th} MOE 408. With respect to the function 310, the weighted scores 414 can be normalized as a function of the priorities 410 to generate the standardized weighted scores 416 (denoted W1jstd). In some cases, the standardized weighted scores 416 may be expressed as follows.

$$W 1 jstd = W 1 j / ( ( {\sum }_{k = 1}^{n} Pk ) / n )$$

Note that this approach may assume that the original scores 406 have a uniform probability density function. A uniform probability density distribution can be defined as X˜U(a, b), where a represents the lowest value of x and b represents the highest value of x. The probability density function can be expressed as f(x)=1/(b−a) for a≤x≤b. In the example shown in FIGS. 4A through 4C, for instance, X˜U(0, 10) and f(x)=1/(10−0) for 0≤X≤10. The theoretical mean u and standard deviation σ of the uniform distribution can be expressed as follows.

$$μ = \frac{a + b}{2}$$

$$σ = \sqrt{\frac{{( b - a )}^{2}}{12}}$$

The second level in the hierarchical-based weighting process can be used to generate the adjusted scores 426, where the second level in the hierarchical-based weighting process is implemented using the function 316. For example, the adjusted scores 426 can be generated as a function of the original scores 406, the priorities 410, and the cutoff 424. Thus, each adjusted score 426 (denoted W2j) may be expressed as follows.

$$W 2 j = f ( S , P , PT )$$

In some embodiments, each adjusted score 426 may be expressed as follows.

$$W 2 j = ( ( {\sum }_{k = 1}^{n} SjkPk ) / n ) PTi$$

Here, PTi represents a multiplier based on the i^{th} person or asset's position in the list 402 relative to the cutoff 424, where 0≤i≤n. In some cases, for instance, the value of PTi may have a value between a minimum of zero and a maximum of one. As a particular example, personnel and/or assets above the cutoff 424 may be assigned a PTi value of one, and personnel and/or assets below the cutoff 424 may be assigned a PTi value of less than one, such as 0.5 or 0.25.

The third level in the hierarchical-based weighting process can be used to generate the one or more additional adjusted scores 428-432, where the third level in the hierarchical-based weighting process is implemented using the functions 318-322. For example, the additional adjusted scores 428-432 can be generated as a function of the original scores 406, the priorities 410, the cutoff 424, and time. Thus, each additional adjusted score 428-432 (denoted W3j) may be expressed as follows.

$$W 3 j = f ( S , P , PT , T )$$

In some embodiments, each additional adjusted score 428-432 may be expressed as follows.

$$W 3 j = ( ( ( {\sum }_{k = 1}^{n} SjkPk ) / n ) PT ) / Ti$$

Here, Ti represents time, and the additional adjusted scores 428-432 are conditioned on the corresponding time period Ti. In some cases, Ti may represent the time period associated with specific CARVER data that corresponds to a time of a mission phase, such as when the time Ti corresponds to a period of at least one hour and no longer than one day.

Each of the three levels of the hierarchical-based weighting process can also be associated with its own unique algorithm(s). For example, the first level of the hierarchical-based weighting process includes an algorithm for weighting scores 406 by priorities 410 to generate weighted scores 414 and standardized weighted scores 416. The second level of the hierarchical-based weighting process includes an algorithm for adjusting the weighted scores 414 or the standardized weighted scores 416 based on whether the associated personnel and/or assets are above or below the cutoff 424.

The third level of the hierarchical-based weighting process can include one or more algorithms that use one or more probability distribution functions or other data characterizations, which can help to increase assessment fidelity and associated confidence. In some cases, the one or more algorithms in the third level can be used to generate final PPL weighted scores. Each final PPL weighted score may be expressed as follows.

$$W = f ( S , P , PT , T , F )$$

Here, F represents a fidelity, which can be determined using an algorithm that applies the fidelity F to the weighting function in order to derive a probability distribution function and an associated confidence (such as a confidence interval). The one or more algorithms in the third level may operate on weighted scores across all MOEs 408 or individual scores for individual MOEs 408. For instance, weighted scores across all MOEs 408 may be subjected to Failure Mode Effectiveness Analysis (FMEA) or Monte-Carlo simulations. FMEA can involve a curve-fitting function from which a probability distribution function (PDF) is derived for each factor of a weighted score. Monte-Carlo simulations can be performed over user likelihood in order to estimate final probability scores and associated confidence intervals for each factor of a weighted score. Individual scores for individual MOEs 408 may be processed using one or more threat-effect characterization algorithms, such as those described in U.S. Patent Publication No. 2023/0334351 (which is hereby incorporated by reference in its entirety). In some cases, the one or more threat-effect characterization algorithms can be based on one or more physics-based models.

As a particular example of this, the curve-fitting function for FMEA can derive a probability distribution function for each MOE 408 based on externally-provided parameters from one or more physics models or from distributions providing ranges for those parameters. For instance, the weighted scores 414 (W1j) may be subjected to the FMEA curve-fitting function in order to identify a skewed normal probability distribution function. A skewed normal distribution is a continuous probability distribution that generalizes a normal distribution to allow for non-zero skewness. For example, let ϕ(x) denote the standard normal probability density function, which can be defined as follows.

$$ϕ ( x ) = \frac{1}{\sqrt{2 π}} {e}^{- \frac{{x}^{2}}{2}}$$

A cumulative distribution function can be defined as follows.

$$Φ ( x ) = {\int }_{- ∞}^{x} ϕ ( t ) dt = \frac{1}{2} [ 1 + erf ( \frac{x}{\sqrt{2}} ) ]$$

Here, erf(·) denotes an error function. Based on this, the probability density function of a skewed normal distribution with a parameter α can be defined as follows.

$$f ( x ) = 2 ϕ ( x ) Φ ( α x )$$

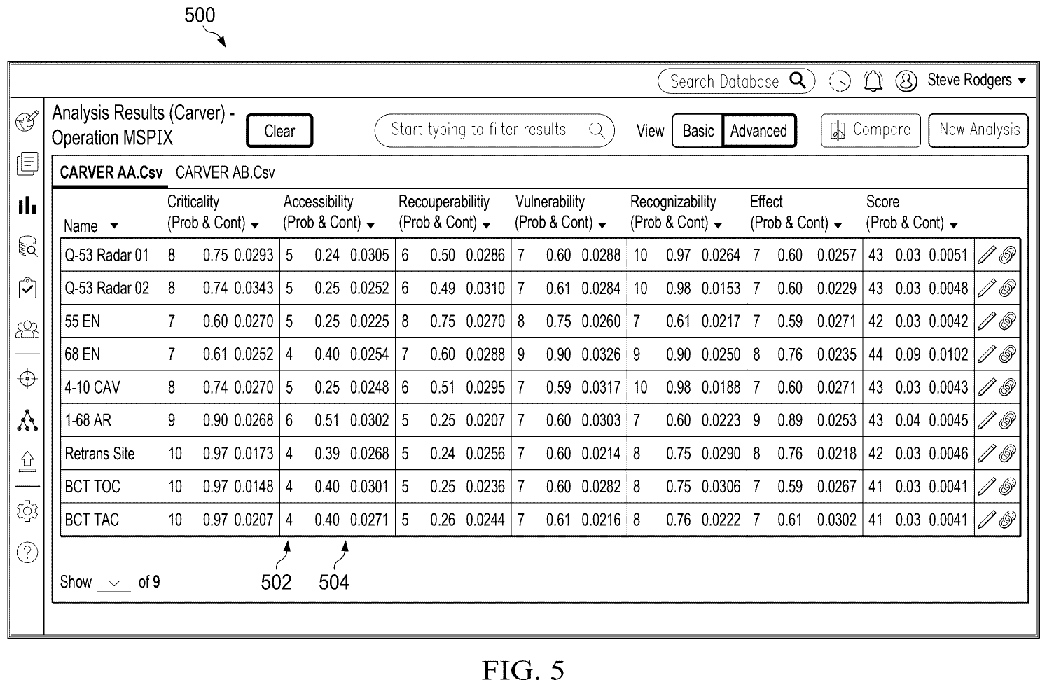

FIG. 5 illustrates example results 500 obtained using the process of FIG. 3 according to this disclosure. As shown in FIG. 5, a graphical user interface can present a listing of personnel and/or assets to a user, along with individual and overall scores 502. Each score 502 can be presented along with a probability and a confidence interval 504. As can be seen here, the FMEA approach can be used to combine an analysis for multiple independent subjective CARVER inputs into a more objective assessment that includes probability and confidence.

The application function 330 can apply one or more AI/ML algorithms to maintain a required or desired level of protection for the personnel and/or assets in a prioritized protection list. Over time (such as during different operational phases), it is possible that the personnel and/or assets in the list 402 may change or that one or more of their scores 406 may change. To address this, the application function 330 can use reinforcement learning (RL) or other AI/ML algorithm to automatically update the list 402 and associated scores 406 for each new operational phase or other time period. In some embodiments, the application function 330 can support an AI/ML-based protection update function (PUF), which may be expressed as follows.

PUF=f(MOE Scores,Weighted MOE Scores,Weighted PPL,COA Feasibility)

Since the protection update function is a predictive function, some embodiments may use Bayesian inference to learn from prior mission/operational phases and associated statistics from MOE analysis. Bayesian inferencing is a method of statistical inferencing in which Bayes' theorem is used to update a probability for a hypothesis as more evidence or information becomes available. For example, consider the equation for W3j provided above. Assume a first mission time period is denoted T₁₁, a second mission time period is denoted T₁₂, and third mission time period is denoted T₁₃. To derive a posterior belief (such as the next MOE score for the k^{th} MOE), Bayes' Rule can be applied by constructing a joint probability equation as follows.

$$P ( B \vert A ) = \frac{P ( A \vert B )}{P ( A )} \times P ( B )$$

Here, P(B|A) represents the posterior belief, P(B) represents a prior belief, and

$$\frac{P ( A \vert B )}{P ( A )}$$

represents a likelihood ratio.

As an example of this, assume W3j₁₁ is the score for the first mission time period and W3j₁₂ is the score for the second mission time period. Based on that, the following can be obtained.

$$P ( W 3 {j}_{22} \vert W 3 {j}_{11} ) = [ P ( W 3 {j}_{11} \vert W 3 {j}_{22} ) / P ( W 3 {j}_{11} ] \times P ( W 3 {j}_{22} )$$

Carrying this approach further to the third time period yields the following.

$$P ( W 3 {j}_{33} \vert W 3 {j}_{22} ) = [ P ( W 3 {j}_{22} \vert W 3 {j}_{33} ) / P ( W 3 {j}_{22} ] \times P ( W 3 {j}_{33} )$$

This approach can therefore be used to derive posterior beliefs for all MOEs 408 for all time periods as a mission or other operation moves forward, thereby updating the PUF as more information becomes available. As a result, this can directly feed an RL or other AI/ML algorithm with reward information that enables AI/ML policy updates. These updates can be used to continuously and automatically update the time-based weighting function for W3j defined above.

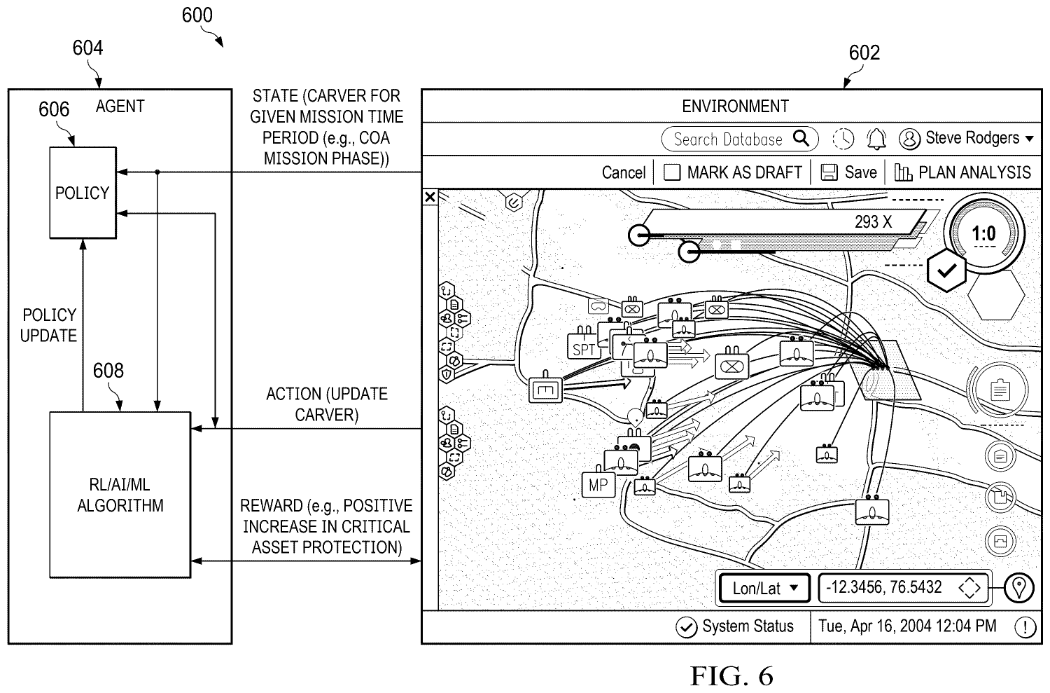

FIG. 6 illustrates an example artificial intelligence/machine learning (AI/ML) approach 600 for establishing and applying policies for protection verification and decision support over time according to this disclosure. As shown in FIG. 6, the AI/ML approach 600 is used in conjunction with an operational environment 602 representing an environment where personnel and/or assets may be protected, where an agent 604 is used to apply machine learning. Using the process 300, a prioritized protection list can be generated for the personnel and/or assets. However, during a mission or other operation, one or more events may occur that could force a change in the state of the matrix table data 404 for a given time period (such as a COA mission phase).

In this example, a policy 606 can be used by an RL or other AI/ML algorithm 608 to process the matrix table data 404 or other aspects of the process 300. A change in the state of the matrix table data 404 for a given time period could cause a change in the policy 606 for the AI/ML algorithm 608. The policy change, coupled with feedback, stimulates the AI/ML algorithm 608 to take action to both update the policy 606 and make recommendations to update the prioritized protection list so that personnel/asset protection positively increases (such as when reflected in the MOE scores 406). Here, the AI/ML algorithm 608 can generate the optimal PUF values in a dynamic environment, where “optimal” refers to collecting the most reward (positively increase personnel/asset protection). The agent 604 can be applied within this approach to explore, interact with, and learn from the environment, such as based on an order of battle for the mission. As learning advances, the AI/ML algorithm 608 can take action that affects the environment and changes state (such as to ensure personnel/assets on the prioritized protection list are protected). Rewards associated with the environment 602 can be generated, such as positive increases in personnel/asset protection, and can inform the agent 604 how well a specific action (for a current PUF value) worked. Based on the received reward, the agent 604 may adjust the action (such as by adjusting the PUF value) in the future.

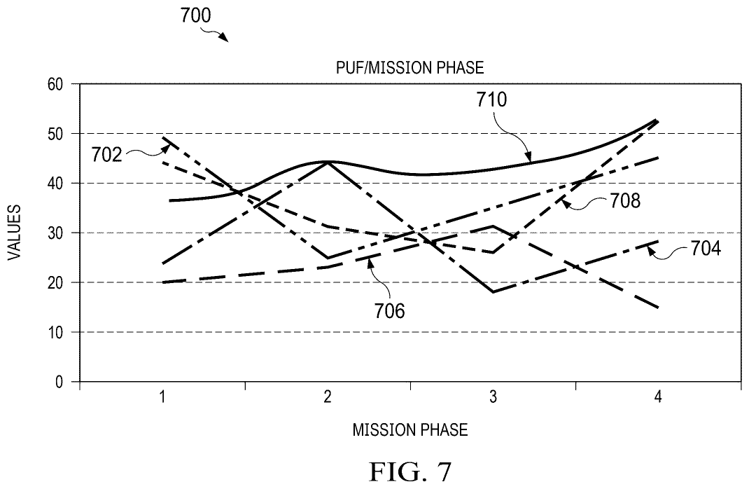

FIG. 7 illustrates example results 700 from using the AI/ML approach 600 of FIG. 6 according to this disclosure. As shown in FIG. 7, lines 702-708 may respectively represent the MOE scores, weighted MOE scores, weighted PPL, and COA feasibility values generated using the process 300. These values are plotted over time for multiple operational/mission phases. A line 710 represents optimized PUF values generated using the AI/ML approach 600 shown in FIG. 6.

Among other things, the process 300 and its related details provided above includes various example novel features. For instance, the described approaches provide a process for transitioning personnel/asset protection decision support from subjective assessments to objective assessments. The described approaches provide a new hierarchical-based weighting process, which can be based on a commander' or other personnel's priorities, to assist with distinguishing the highest-priority personnel/assets to protect while considering relevant measures of effectiveness. The described approaches provide new algorithms with additional hierarchical levels of personnel/asset priority assessment that increase assessment fidelity and associated confidence based on probability distribution functions and data characterizations. The described approaches provide a mechanism to apply artificial intelligence or other machine learning techniques (such as new reinforcement learning algorithms) to dynamically establish and apply policies for a protection update function and optimization of critical personnel/asset protection during mission/operation execution across the mission/operation timeline.

Although FIGS. 3 through 7 illustrate one example of a process 300 supporting adaptable, scalable, and autonomous protection verification and decision support and related details, various changes may be made to FIGS. 3 through 7. For example, various functions in the process 300 may overlap, occur in parallel, occur in a different order, or occur any number of times (including zero times).

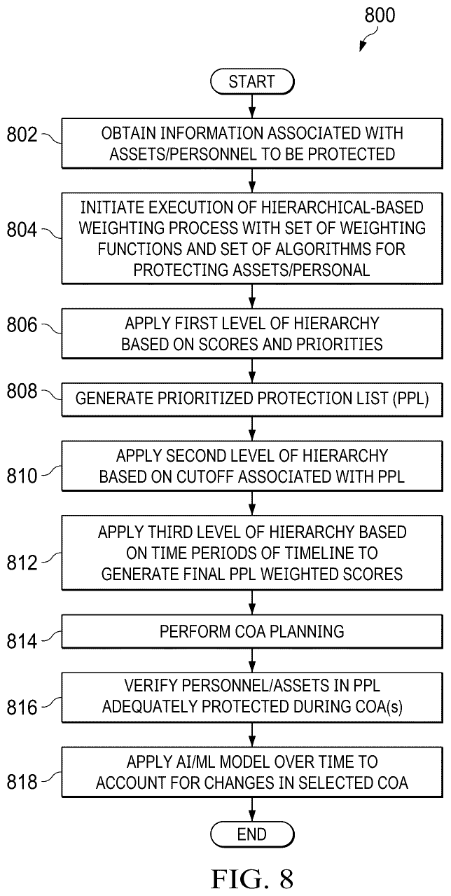

FIG. 8 illustrates an example method 800 for adaptable, scalable, and autonomous protection verification and decision support according to this disclosure. For ease of explanation, the method 800 shown in FIG. 8 is described as being performed by the application server 106 in the system 100 shown in FIG. 1, which can be implemented using one or more instances of the device 200 shown in FIG. 2 and which can implement the process 300 shown in FIG. 3. However, the method 800 may be performed using any other suitable device(s) and process(es) and in any other suitable system(s).

As shown in FIG. 8, information associated with assets and/or personnel to be protected is obtained at step 802. This may include, for example, the processing device 202 of the application server 106 obtaining matrix table data 404 for a list 402 of personnel and/or assets to be protected. This can be subjective data and may be provided by any suitable users, such as one or more mission commanders or other people responsible for overseeing use of the personnel and/or assets.

Execution of a hierarchical-based weighting process is initiated at step 804. This may include, for example, the processing device 202 of the application server 106 initiating processing of the matrix table data 404 using a set of weighting functions and a set of algorithms for protecting the assets and/or personnel in the list 402. The weighting functions and the algorithms are arranged in multiple levels of the hierarchy. Each level of the hierarchy can be associated with one or more priorities, one or more mission objectives, and/or one or more desired outcomes. In some cases, processing resources to be used to perform the hierarchical-based weighting process can be dynamically scaled, such as by increasing or decreasing the processing resources based on the number of assets and/or personnel to be protected. This allows the described techniques to accommodate protection decision-making associated with an increasing or decreasing number of assets and/or personnel.

A first level of the hierarchy is applied at step 806, and a prioritized protection list is generated based on the results at step 808. This may include, for example, the processing device 202 of the application server 106 generating weighted scores 414 and standardized weighted scores 416 for each asset and/or person in the list 402. This may also include the processing device 202 of the application server 106 identifying a cutoff 424, such as based on the number of assets and/or personnel for which protection is to be prioritized. This may further include the processing device 202 of the application server 106 reordering the list 402 based on the weighted scores 416 and identifying assets and/or personnel above the cutoff 424. These assets and/or personnel can form the prioritized protection list. A second level of the hierarchy is applied at step 810. This may include, for example, the processing device 202 of the application server 106 applying a weighting of less than one to scores of assets and/or personnel below the cutoff 424.

A third level of the hierarchy is applied based on time periods of a timeline to generate final PPL weighted scores at step 812. This may include, for example, the processing device 202 of the application server 106 determining weighted scores for the assets and/or personnel in the reordered list 402 during different operational/mission phases. This may also include the processing device 202 of the application server 106 applying one or more probability distribution functions across the timeline or otherwise applying one or more of the weighting functions and one or more of the algorithms across the timeline to increase assessment fidelity and associated confidence.

Course of action planning can be performed at step 814. This may include, for example, the processing device 202 of the application server 106 allowing one or more users to use an operations planning tool to examine potential courses of action involving the assets and/or personnel. As part of this process, it can be verified whether the assets and/or personnel on the prioritized protection list are adequately protected at step 816. This may include, for example, the processing device 202 of the application server 106 determining whether a known set of defense assets for each course of action could provide adequate protection for the personnel and/or assets in the prioritized protection list. If not, changes may be made, such as to the available set of defense assets or the course of action.

AI/ML can be applied over time to account for changes in a selected COA at step 818. This may include, for example, the processing device 202 of the application server 106 performing the AI/ML approach shown in FIG. 6 to determine whether the personnel and/or assets in the prioritized protection list remain adequately protected as COA changes occur. If not, changes may be made, such as to the available set of defense assets or the course of action being executed.

Although FIG. 8 illustrates one example of a method 800 for adaptable, scalable, and autonomous protection verification and decision support, various changes may be made to FIG. 8. For example, while shown as a series of steps, various steps in FIG. 8 may overlap, occur in parallel, occur in a different order, or occur any number of times (including zero times).

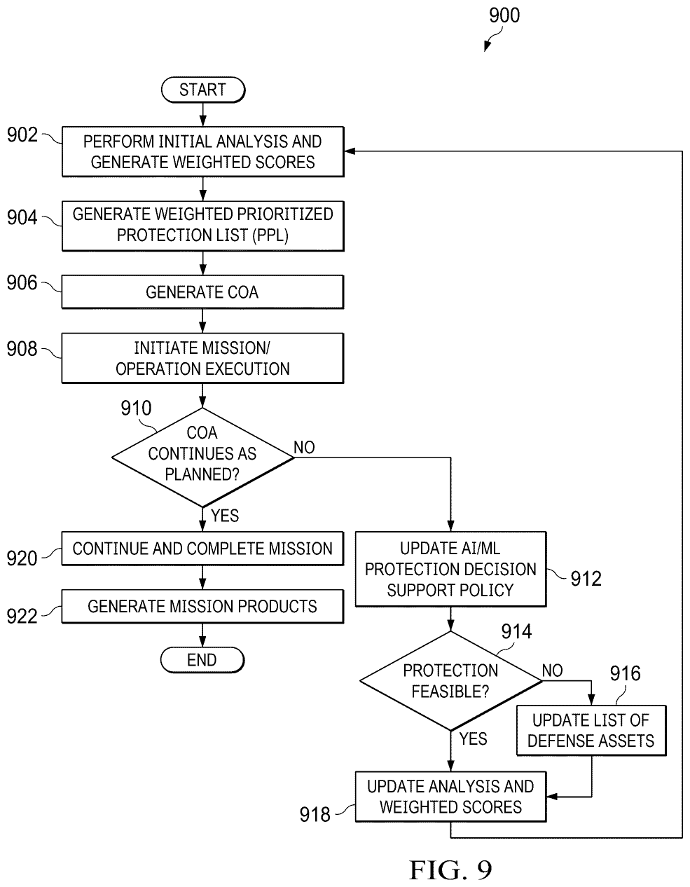

FIG. 9 illustrates an example method 900 for using AI/ML to establish and apply policies for protection verification and decision support over time according to this disclosure. For ease of explanation, the method 900 shown in FIG. 9 is described as being performed by the application server 106 in the system 100 shown in FIGURE, which can be implemented using one or more instances of the device 200 shown in FIG. 2 and which can implement the process 300 shown in FIG. 3. However, the method 900 may be performed using any other suitable device(s) and process(es) and in any other suitable system(s).

As shown in FIG. 9, an initial analysis is performed and weighted scores are generated at step 902, a weighted PPL is generated at step 904, and a course of action is generated at step 906. This may include, for example, the processing device 202 of the application server 106 performing the steps 802-814 shown in FIG. 8. Execution of the planned mission or other operation with the generated course of action is initiated at step 908. This may include, for example, a civilian or military operation commencing using the generated course of action. A determination is made whether the generated course of action continues as planned during the mission or other operation at step 910. If so, the mission can continue and be completed at step 920, and one or more mission products may be generated at step 922. The one or more mission products may represent any suitable information associated with the execution of the mission or other operation, such as a detailed asset protection plan.

Otherwise, the generated course of action may have unexpectedly changed, and an AI/ML protection decision support policy is updated at step 912. This may include, for example, the processing device 202 of the application server 106 updating the policy 606, such as by using reinforcement learning based on a maximum reward. A determination is made whether protection for the assets and/or personnel in the prioritized protection list is feasible at step 914. This may include, for example, the processing device 202 of the application server 106 using the operations planning tool to determine whether the available set of defense assets is estimated to adequately protect the assets and/or personnel in the prioritized protection list. If not, the list of potential defense assets may be updated at step 916. This may include, for example, the processing device 202 of the application server 106 determining whether adding one or more additional defense assets to the available set allows the assets and/or personnel in the prioritized protection list to be adequately protected. When protection of the assets and/or personnel in the prioritized protection list is feasible (either from step 914 or 916), an updated analysis and weighted scores can be generated at step 918. This can occur in the same or similar manner as the original analysis and weighted scores. The process can return to step 904 to repeat the process with the updated analysis and weighted scores.

Although FIG. 9 illustrates one example of a method 900 for using AI/ML to establish and apply policies for protection verification and decision support over time, various changes may be made to FIG. 9. For example, while shown as a series of steps, various steps in FIG. 9 may overlap, occur in parallel, occur in a different order, or occur any number of times (including zero times).

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
obtaining information associated with assets and/or personnel to be protected;
executing a set of weighting functions and a set of algorithms for protecting the assets and/or personnel, the weighting functions and algorithms arranged in multiple levels of a hierarchy;
wherein each level of the hierarchy includes one or more of the weighting functions and one or more of the algorithms; and
wherein the one or more weighting functions and the one or more algorithms in at least one level of the hierarchy are applied across a timeline; and
applying an artificial intelligence/machine learning (AI/ML) algorithm across the timeline to update results due to one or more changes during one or more operations involving the assets and/or personnel.

2. The method of claim 1, wherein, for at least one level of the hierarchy, the one or more weighting functions and the one or more algorithms are applied across the timeline based on one or more probability distribution functions.

3. The method of claim 2, wherein the one or more probability distribution functions are derived through curve fitting.

4. The method of claim 1, wherein the AI/ML algorithm is configured to dynamically establish and apply policies for a protection update function and optimization of critical personnel or asset protection across the timeline.

5. The method of claim 4, wherein the AI/ML algorithm comprises a reinforcement learning algorithm.

6. The method of claim 1, further comprising:
dynamically scaling processing resources to accommodate protection decision-making associated with an increasing or decreasing number of assets and/or personnel to be protected prior to and during the timeline.

7. The method of claim 1, wherein:
each level of the hierarchy is associated with at least one of: one or more priorities, one or more mission objectives, and one or more desired outcomes; and
the AI/ML algorithm increases assessment fidelity and associated confidence.

8. An apparatus comprising:
at least one processing device configured to:
obtain information associated with assets and/or personnel to be protected;
execute a set of weighting functions and a set of algorithms for protecting the assets and/or personnel, the weighting functions and algorithms arranged in multiple levels of a hierarchy;
wherein each level of the hierarchy includes one or more of the weighting functions and one or more of the algorithms; and
wherein the one or more weighting functions and the one or more algorithms in at least one level of the hierarchy are applied across a timeline; and
apply an artificial intelligence/machine learning (AI/ML) algorithm across the timeline to update results due to one or more changes during one or more operations involving the assets and/or personnel.

9. The apparatus of claim 8, wherein, for at least one level of the hierarchy, the at least one processing device is configured to apply the one or more weighting functions and the one or more algorithms across the timeline based on one or more probability distribution functions.

10. The apparatus of claim 9, wherein the at least one processing device is further configured to derive the one or more probability distribution functions through curve fitting.

11. The apparatus of claim 8, wherein the AI/ML algorithm is configured to dynamically establish and apply policies for a protection update function and optimization of critical personnel or asset protection across the timeline.

12. The apparatus of claim 11, wherein the AI/ML algorithm comprises a reinforcement learning algorithm.

13. The apparatus of claim 8, wherein the at least one processing device is further configured to dynamically scale processing resources to accommodate protection decision-making associated with an increasing or decreasing number of assets and/or personnel to be protected prior to and during the timeline.

14. The apparatus of claim 8, wherein:
each level of the hierarchy is associated with at least one of: one or more priorities, one or more mission objectives, and one or more desired outcomes; and
the AI/ML algorithm is configured to increase assessment fidelity and associated confidence.

15. A non-transitory computer readable medium containing instructions that when executed cause at least one processor to:
obtain information associated with assets and/or personnel to be protected;
execute a set of weighting functions and a set of algorithms for protecting the assets and/or personnel, the weighting functions and algorithms arranged in multiple levels of a hierarchy;
wherein each level of the hierarchy includes one or more of the weighting functions and one or more of the algorithms; and
wherein the one or more weighting functions and the one or more algorithms in at least one level of the hierarchy are applied across a timeline; and
apply an artificial intelligence/machine learning (AI/ML) algorithm across the timeline to update results due to one or more changes during one or more operations involving the assets and/or personnel.

16. The non-transitory computer readable medium of claim 15, wherein, for at least one level of the hierarchy, the instructions when executed cause the at least one processor to apply the one or more weighting functions and the one or more algorithms across the timeline based on one or more probability distribution functions.

17. The non-transitory computer readable medium of claim 15, wherein the AI/ML algorithm is configured to dynamically establish and apply policies for a protection update function and optimization of critical personnel or asset protection across the timeline.

18. The non-transitory computer readable medium of claim 17, wherein the AI/ML algorithm comprises a reinforcement learning algorithm.

19. The non-transitory computer readable medium of claim 15, further containing instructions that when executed cause the at least one processor to:
dynamically scale processing resources to accommodate protection decision-making associated with an increasing or decreasing number of assets and/or personnel to be protected prior to and during the timeline.

20. The non-transitory computer readable medium of claim 15, wherein:
each level of the hierarchy is associated with at least one of: one or more priorities, one or more mission objectives, and one or more desired outcomes; and
the AI/ML algorithm is configured to increase assessment fidelity and associated confidence.
